(19) United States
(12) Patent Application Publication
(10) Pub. No.: US 2013/0112758 A1
(43) Pub. Date: May 9, 2013

(54) SYSTEM AND METHOD FOR APPLYING MAGNETIC STRIP ONTO CARDS

(71) Applicant: PROFOLD, INC., Sebastian, FL (US)

(72) Inventor: Richard EDMISTEN, Sebastian, FL (US)

(73) Assignee: PROFOLD, INC., Sebastian, FL (US)

(21) Appl. No.: 13/670,496

(22) Filed: Nov. 7, 2012

Related U.S. Application Data
(60) Provisional application No. 61/557,528, filed on Nov. 9, 2011.

(51) Int. Cl. B05D 5/12; G06K 19/06

(52) U.S. Cl. CPC B05D 5/12; G06K 19/06196
USPC 235/493; 427/487; 118/620

(57) ABSTRACT

A method of forming a card having a magnetic strip is disclosed and includes advancing a planar card member along a predetermined path of travel. The card member has opposing surfaces. A longitudinal strip of slurry comprising magnetically conductive particles is applied onto a surface of the card member. The magnetically conductive particles are magnetically aligned. The longitudinal strip of magnetically conductive particles are radiation cured to form the magnetic strip on the surface of the card member.

### FIELD OF THE INVENTION

This invention relates to applying a magnetic strip onto cards and similar items.

### BACKGROUND OF THE INVENTION

U.S. Pat. No. 6,729,656 discloses a debit card having an applied personal identification number (PIN) and scratch-off coating and method of forming same. The process and machinery as described is sold under the tradename “Pro-Tech” by Profold, Inc. of Sebastian, Fla. In the '656 patent, a PIN is printed onto the surfaces of the planar card member and is advanced along a predetermined path of travel. A radiation cured, opaque scratch-off coating is applied onto the surface of the PIN. The scratch-off coating can be radiation cured, preferably by ultraviolet radiation. In one example, three printing stations are disclosed in its FIG. 1 and labeled 1, 2 and 3 and referred to the numeral indicia 20A, 20B and 20C. Print stations include metering rolls in the form of an anilox metering roll, a plate cylinder having impression plates such as print pads as commonly used in flexographic printing systems, and an ultraviolet curing station such as an ultraviolet curing lamp. The PIN is printed onto the surface of the planar card such as by a PIN print station, which could be an ink jet print station. A release coating could be applied over the PIN such as at station 1 followed by a scratch-off coating. The magnetic strip has already been applied to the card in the embodiment disclosed in the '656 patent.

It is desirable to use the process disclosed in the '656 patent and also apply a magnetic strip such as using the process disclosed in the '656 patent.

### SUMMARY OF THE INVENTION

A method of forming a card having a magnetic strip is disclosed and includes advancing a planar card member along a predetermined path of travel. The card member has opposing surfaces. A longitudinal strip of slurry comprising magnetically conductive particles is applied onto a surface of the card member. The magnetically conductive particles are magnetically aligned. The longitudinal strip of magnetically conductive particles are radiation cured to form the magnetic strip on the surface of the card member.

In accordance with a non-limiting example, data is encoded onto the magnetic strip. In another example, the longitudinal strip of slurry is printed such as by metering the slurry from an anilox metering roll onto an impression plate and transferring the slurry from the impression plate onto the surface of the planar card member. In another example, the magnetically conductive particles are magnetically aligned by applying an electric field to the magnetically conductive particles. The amplitude of a current forming the electric field can be varied to change the magnetism imparted onto the magnetically conductive particles.

In yet another example, a debit card is formed as a planar card member having opposing surfaces. A longitudinal magnetic strip is applied onto a surface of the planar card member and formed from a radiation cured slurry of magnetically aligned conductive particles applied onto a surface of the card. Data is encoded onto the magnetic strip in one example.

### BRIEF DESCRIPTION OF THE DRAWINGS

Other objects, features and advantages of the present invention will become apparent from the detailed description of the invention, which follows when considered in light of the accompanying drawings in which:

FIG. 1 is a block diagram of the system and apparatus used for producing the debit card and showing basic components.

FIG. 2 is an isometric view of a print station used for applying a scratch-off coating (or release coat) onto a planar card member, which is followed by ultraviolet/radiation curing of the scratch-off coating (or release coat).

FIG. 3 is an enlarged isometric view of a print station having a metering roll, plate cylinder, and impression plate (print pad) used for transferring scratch-off material from the impression plate onto the surface of the planar card member that is advanced along a conveyor under the print station.

FIGS. 4 and 5 show opposing sides of a debit card in the form of a telephone calling card and having the scratch-off coating applied over a PIN.

FIG. 6 is an exaggerated sectional view of a first embodiment of a debit card showing a scratch-off coating applied over a PIN.

FIG. 7 is an exaggerated sectional view of a second embodiment of a debit card showing a printed scratch-off coating and printed second coating applied over a PIN.

FIG. 8 is another block diagram of the system and apparatus used for producing the card having a magnetic strip of the present invention and showing basic components for forming the debit card and applying a magnetic strip using a magnetic slurry.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

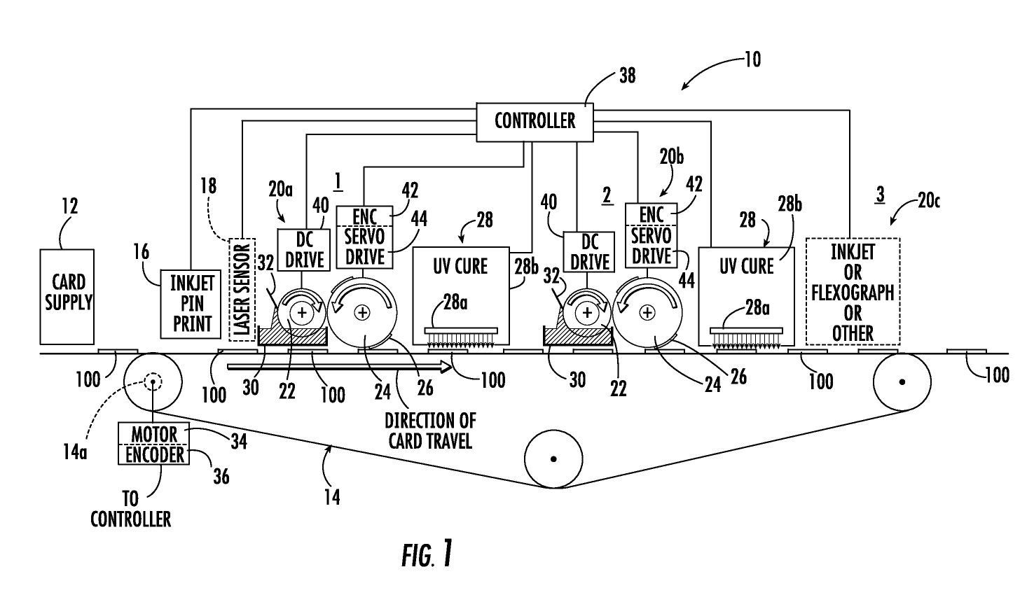

There is now disclosed the method of forming the card that has a magnetic strip that also includes relative to FIG. 8 a system and method of applying a magnetic strip using a magnetic slurry. For purposes of description, the “Pro-Tech” process is described relative to FIGS. 1-7 as described in the '656 patent and the process is later described relative to applying a magnetic strip when described relative to FIG. 8.

Referring now to FIG. 1, there is illustrated at 10 a general block diagram of the system and apparatus that can be used for forming the debit card that can include a magnetic strip, which can be applied using the system of FIG. 8 or pre-applied from a roll of magnetic strip material. A card supply 12, such as a card hopper, stores planar card members that are to be advanced along a predetermined path of travel via a conveyor system 14, typically a belt conveyor having a vacuum draw mechanism for securing cards and other articles thereon. An example of such a card supply 12 and conveyor system 14 could be the type disclosed in the incorporated by reference and commonly assigned U.S. Pat. No. 6,199,757 to Profold, Inc. of Sebastian, Fla., the disclosure which is hereby incorporated by reference in its entirety. Naturally, the invention is not limited to such belt conveyor systems, and other card conveyance systems could be used as suggested by those skilled in the art.

Although different planar card members can be used for the purposes of the present invention, typical planar card members can be formed as a plastic substrate, including plastics such as polyvinyl chloride (PVC), acrylonitrile-butadiene-styrene (ABS), other styrene polymers, polyester (PET), and other materials commonly used for substrates in the credit card and telephone calling card industry. Typically, the substrate thickness varies from about 0.007 inches up to about 0.032 inches. Also, in other aspect of the present invention, common single ply, but somewhat thick and rigid paper, or multi-ply or other different paper substrates, could be used for the present invention.

As shown in FIG. 1, the system 10 includes a PIN print station 16 where personal identification numbers (PIN'S) are printed on a surface of the debit card, such as by an ink jet printer or other print means. The print station 16 prints onto the surface of planar card members as they advance along a predetermined path of travel defined by the conveyor 14. It is possible that the card members could be printed with PIN's off-line, or in another location in an in-line position. The illustrated embodiment, however, shows the ink jet printing of PIN'S occurring just before sensing of the cards by a laser sensor 18. Three print stations 20a, 20b and 20c are labeled 1, 2 and 3 and positioned adjacent the conveyor 14. The first two print stations 20a, 20b include a metering roll 22 in the form of an anilox metering roll, a plate cylinder 24 having impression plates (print pads) 26 as commonly used in flexographic printing systems, and an ultraviolet curing station 28 in the form of an ultraviolet curing lamp. The third station 20c could be a similar station as stations 1 and 2, or could be an ink jet spray station or other printing station that applies a second and/or subsequent ink layers or other coatings over the opaque scratch-off coating.

After the PIN is printed onto the surface of the planar card member by PIN print station 16, the debit card is advanced in a predetermined path of travel by the belt conveyor where, in one example, a release coating is applied over the PIN. The release coating is typically less than about 2 mil thickness and preferably about 0.0002 to about 0.0005 inches thick and could range up to about 0.002 inches. The release coating is preferably transparent, but it does not have to be necessarily clear, but could be color tinted for aesthetic purposes. Typically, the release coating (if used) should be of a thickness and color such that the PIN can be seen through the release coating.

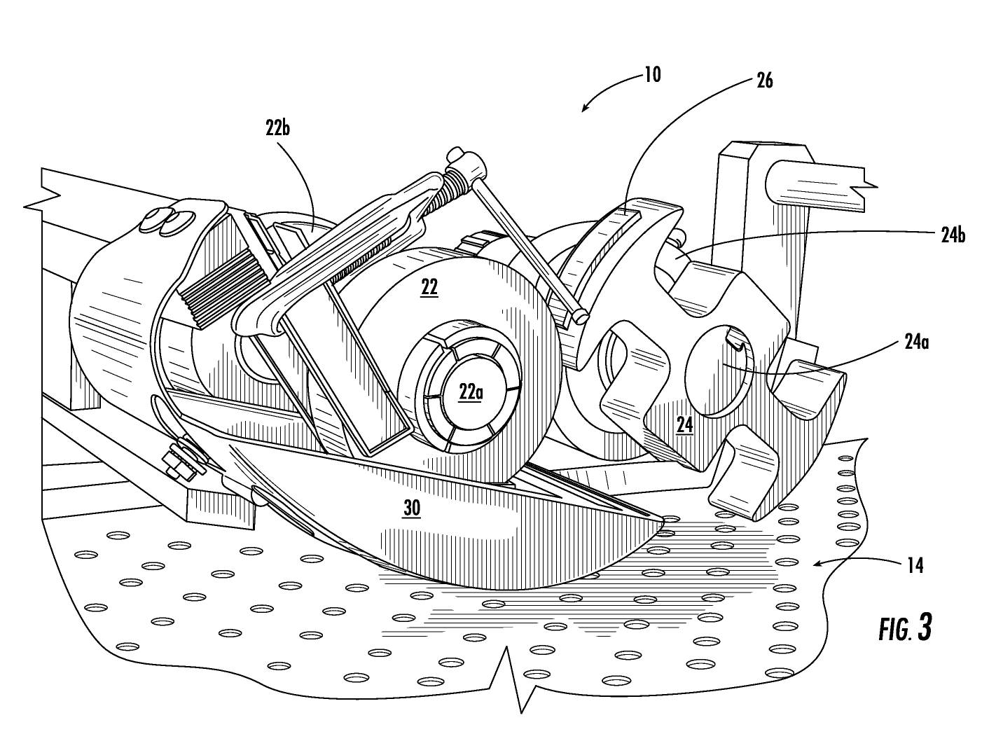

The release coating is applied by printing the release coating using a metering roll 22 and impression plate 26 in a flexographic printing process. Other printing methods that could be used include rotary letter press, offset (lithography), gravure, and rotary screen printing methods. The preferred printing method has been found to be the flexographic printing method, and includes an ink reservoir 30 in the form of an ink bath container, as shown in FIG. 3. The bath container 30 holds the ink in liquid form, which could be the release material or scratch-off material. The ink bath container could be a chambered doctor blade system or other enclosed doctor blade system. Although an open system is illustrated for purposes of description, a chambered doctor blade system would provide cleaner operation.

The anilox metering roll 22, as known to those skilled in the art, is contained within the ink bath and includes the common knurled or other surface. A doctor blade 32 is operative with the metering roll 22 for engaging close to the metering roll and removing part of the liquid or ink in the form of the release material or scratch-off material from the anilox metering roll.

The plate cylinder 24 has impression plates 26 in the form of print pads mounted thereon that engage the anilox metering roll and transfers the release or scratch-off coating material from the plate (pads) onto the surface of the planar card member. The plate cylinder 24 is a generic term describing many types of flexographic design options. As shown in FIG. 3, the plate cylinder 24 can be formed similar to a bar bell configuration for saving weight by having less metal or other support structure that is rotated. The illustrated configuration allows two print pads 26. Other designs could support three or four print pads, essentially doubling throughput when four print pads are used. The impression plates (print pads) 26 can be formed of any type of material commonly known to those skilled in the art, including rubber print pads or photopolymer plates 26 and/or other flexible plate or pad material, typically known and used by those skilled in the art.

The release coating can be applied in a printing manner similar to any ink coating applied in printing techniques, including the preferred flexographic techniques. This release coating can, thus, be referred to as a printed ink coating that is applied onto the surface of the card over the PIN and radiation/ultraviolet cured by the preferred ultraviolet curing lamp 28, which uses an ultraviolet bulb 28a in an ultraviolet lamp housing 28b.

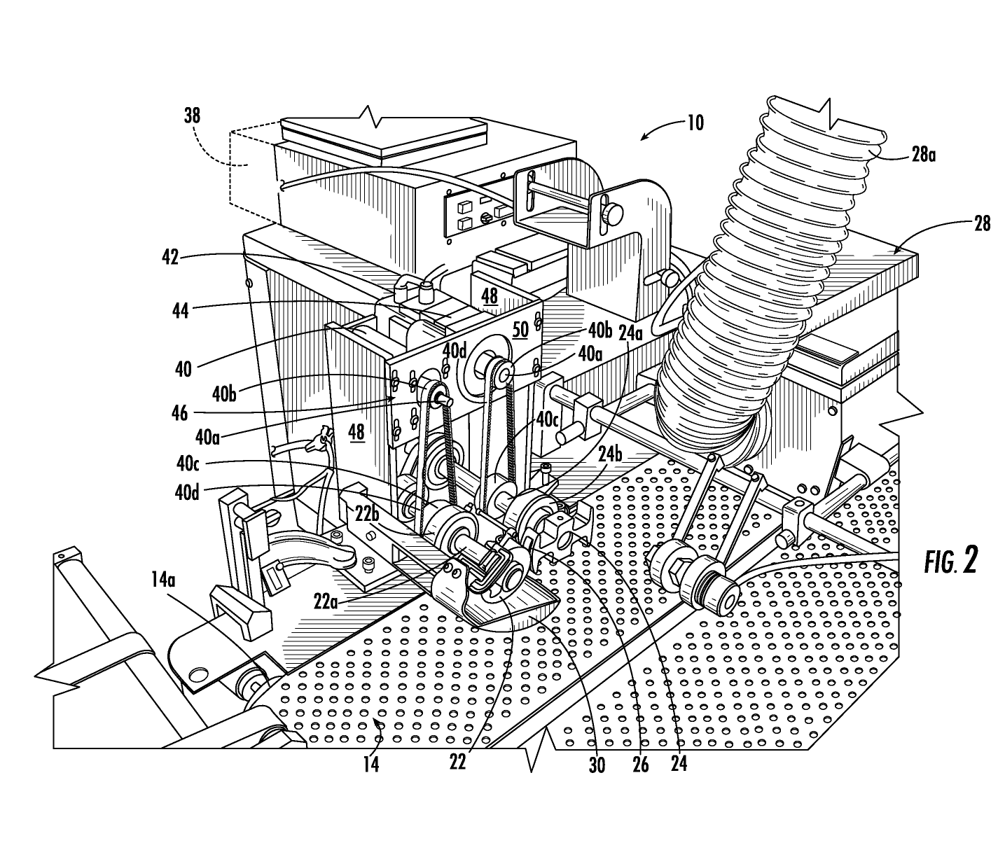

The belt conveyor 14 typically includes a servodrive in the form of a servomotor 34 operatively connected onto a support shaft 14a of the belt conveyor. An encoder 36 is operatively connected to the shaft 14a and a controller 38. The laser sensor 18 is operative with the conveyor, as shown in FIGS. 1 and 2, and is operatively connected to the controller 38. A DC motor drive 40 is operatively connected to the anilox metering roll 22, but a more accurate servomotor could be used instead of the DC motor drive, especially with high speed operation. An encoder 42 and servomotor 44 are operatively connected to the plate cylinder 24 to establish precise and controlled movement of the plate cylinder, and thus, controlled movement of the impression plates (print pads) 26 in timed operation with a card moving under the plate cylinder as the card member advances along its predetermined path of travel. The servomotor has about 4,000 pulses per revolution of its output shaft to give high accuracy to the system.

Naturally, a release coating is not always necessary depending on the type of substrate used for the card member. The amount of surface tension created by the card surface has an impact on the removability of opaque scratch-off layers, typically formed as a silver ink, as known to those skilled in the art, such that the scratch-off layer could be removed without damaging the PIN even without a release coating, in some instances.

At the second print station 22b, the scratch-off coating is applied after the first print station 22a has printed a release coating in this non-limiting example. As is typical, the scratch-off coating can be a silver ink formed of a material known to those skilled in the art, but could be formed of another type of opaque ink. The print station 22b is similar in design to the first print station 22a and includes the basic printing components as described before, including an anilox metering roll 22 and plate cylinder 24, the appropriate ink well or reservoir 30, doctor blade 32, DC motor drive 40, servodrive mechanism in the form of a precisely controlled servomotor 44, encoder 42, and impression plates or print pads 26 contained on the plate cylinder. A second ultraviolet curing station (lamp) 28 provides for radiation curing of the printed ink in the form of the opaque scratch-off coating. Although ultraviolet curing is the preferred method of curing as described, it is possible in some cases to use other types of radiation curing, including the possible use of electron beam, blue light, laser or other radiation curing methods known to those skilled in the art.

The ultraviolet curing stations 28 used in the present invention are an ultraviolet, modular curing subsystems, such as manufactured and sold by Uvexs of Sunnyville, Calif. Such ultraviolet curing stations include an ultraviolet lamp housing that could use a metal halide, mercury vapor, or other type of ultraviolet lamp known to those skilled in the art with power levels ranging from as low as about 100 watts/inch to as high as about 600 watts/inch. If a release coating is applied, then a mercury vapor lamp could be used. For the opaque scratch-off coating, a metal halide lamp is preferred, but of course, other lamps could be used as suggested by those skilled in the art. The station could have remote operating controls for operator control at a console located a distance from the system, and an adequate power supply for direct ultraviolet exposure (and infrared filter exposure in some cases). The station 28 could also include an internal shutter and a digital exposure timer having a continuous variable power control.

The station 28 could provide surface and in-depth curing for high intensity, full spectrum ultraviolet energy from about 200 to about 400 nanometers. The lamp lengths can vary from as little as 2 to about BO or more inches and include a single medium pressure mercury vapor, metal halide, or other lamp. Internal cooling fans could be provided with appropriate venting using vent systems 28a as shown in FIG. 2. A reflector could be included in the oven for unfiltered and filtered infrared operation. The shutter could allow exposure control and could be provided by an internally mounted knife blade shutter using a pneumatic cylinder to drive the shutter plate at an adjustable open/close rate. Clean dry air or nitrogen could be used for efficient curing operation. The shutter control could include a pneumatic switch and digital timer for open/close functions. A programmable logic control (PLC) can be used as an interface connector using techniques known to those skilled in the art. Variable power control can provide power control over the ultraviolet lamp.

FIG. 2 illustrates further details of a print station 20a or 20b. Only one print station 20b is illustrated for applying a scratch-off coating over the PIN onto a surface of the planar card member without use of a release coating. Naturally, one or more print stations can be used for the present invention, including the three print stations 20a-c as shown in FIG. 1. Although an open ink reservoir is illustrated, as noted before, a chambered doctor blade system is preferred.

As illustrated in FIG. 2, as a non-limiting example, the anilox metering roll 22 and plate cylinder 24 are each supported on respective support or drive shafts 22a, 24 that are mounted for rotation in respective bearing housings 22b, 24b. The servomotor 44 and DC drive motor 40 are supported by a motor mount 46 (or stand) that includes side support plates 48, a front face plate 50, and a lower support plate (not shown) that supports the motors 44, 40. This motor mount 46 is secured to the conveyor 14 by appropriate fastening and attachment means known to those skilled in the art. A DC drive motor output shaft 40a includes a timing belt pulley 40b that is operatively connected to another timing belt pulley 40c on the anilox metering roll support shaft via a timing belt 40d.

A timing belt pulley 44b is mounted on the output drive shaft 44a of the servomotor 44 and is operatively connected to another timing belt pulley 44c mounted on the plate cylinder support shaft via a timing belt 44d. These drive mechanisms provide controlled movement of the metering rolls and plate cylinders.

The third print station 20c can be used for personalization and can include a similarly fabricated, flexographic print station as described for the first and second print stations, or could be another type of printing apparatus besides the described flexograph type of printing station. The third print station 20c applies a second coat of ink, scratch-off coating material, or other printed indicia over the first scratch-off coating. Naturally, the print station 20c location would vary if it is used to print a layer over the PIN before application of the scratch-off coating. The third print station could be an ink jet print station and apply a fingerprint pattern or similar pattern that is opaque over (or under depending on position of the print station) the scratch-off coating. Also the ink jet printing could apply a security indicia on the opaque scratch-off coating that could be a control code. Thus, if the scratch-off coating and control code were removed, and a scratch-off label applied in its place, then a user would know that tampering of the card has occurred because there would be no control code. Also, the control code could be used for further security and correspond to other control codes printed on the planar card member. During ink jet printing of the second layer, coating, or indicia after the scratch-off coating has been applied, a typical black ink can be provided, although other ink could be provided as known to those skilled in the art.

The controller 38 could be a personal computer or other controller system as known to those skilled in the art. The ink jet PIN print station 16, laser sensors 18, DC motor drives 40, servodrives (motors) 34, 44, encoders 36, 42, shutter controls for the UV station 28, and any other motors and encoders used for the belt conveyor 14 and other components of the system are all operatively connected to the controller.

In operation, the laser sensor 18 senses the leading edge of an advancing card member and registers this edge position to the controller. Throughout the card advancing process, the drive motors and encoder of the conveyor belt drive maintains accurate positional control over the card at all times. The servodrive (motor) 44 that is operatively connected to each of the plate cylinders 24 maintains rotational control to apply the release and scratch-off coatings at a timed moment such that any coatings are applied at a specific location on the surface of a card. In one aspect of the invention, the software system uses a “queue” that is internal to a tracking subroutine within the drive encoder and controller that tracks the product with the belt conveyor. If a gap varies between cards, the system still tracks all cards by placing the known location within the “queue” and knowing the time it takes for sensing a card to the time the card moves into a printing station.

The thickness of the scratch-off coating, release coating, or other coatings can be set not only by the configuration of the knurls in any anilox metering roll, but also by the type of doctor blade setting used in conjunction with the metering roll. The surface speed of the knurled anilox metering roll is set to the surface speed of the conveyor belt such that the speeds are synchronized. The speeds of the card relative to the curing time can be varied.

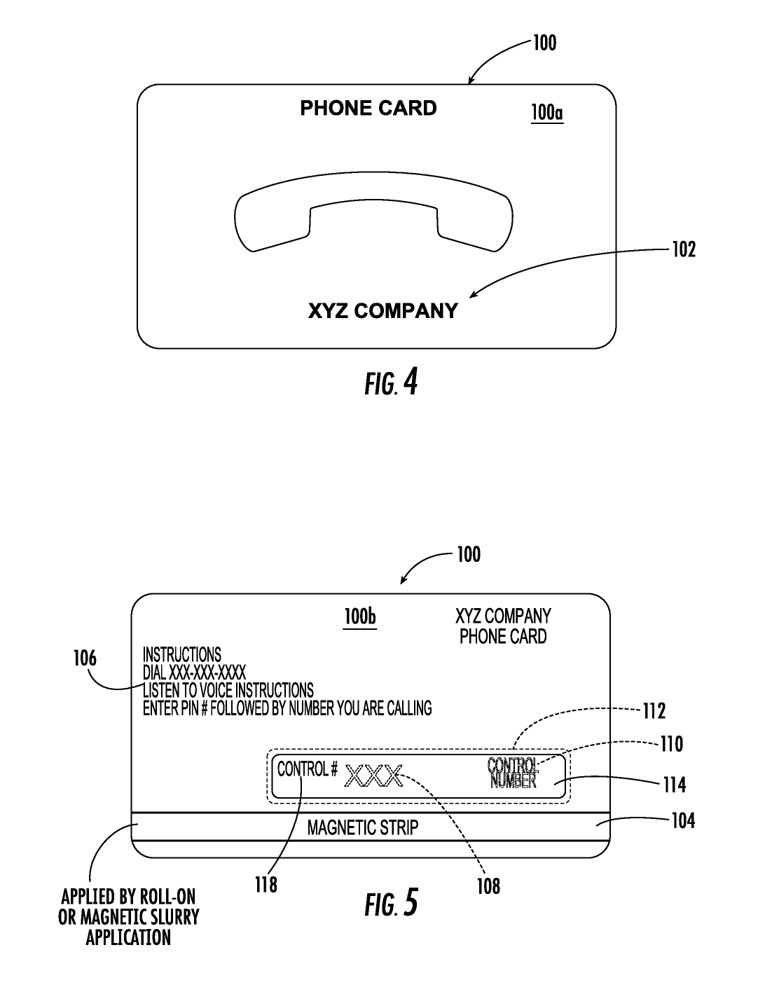

FIGS. 4 and 5 illustrate respective front and rear surfaces or faces 100a, 100b of a debit card 100, such as the illustrated phone card. FIG. 4 shows that the phone card 100 includes typical identification information 102 on the front face 100a. The rear surface 100b includes a magnetic strip 104 as is common with some types of phone cards. This magnetic strip can be applied in a conventional manner by applying a strip using an applicator that applies magnetic strip material from a roll, in one example. In another example and as discussed relative to FIG. 8, the magnetic strip is applied from a magnetic slurry using the process as described relative to stations 1 and 2 corresponding to print stations 20A and 20B. Other types of magnetic slurry applicators could be used including an ink jet applicator.

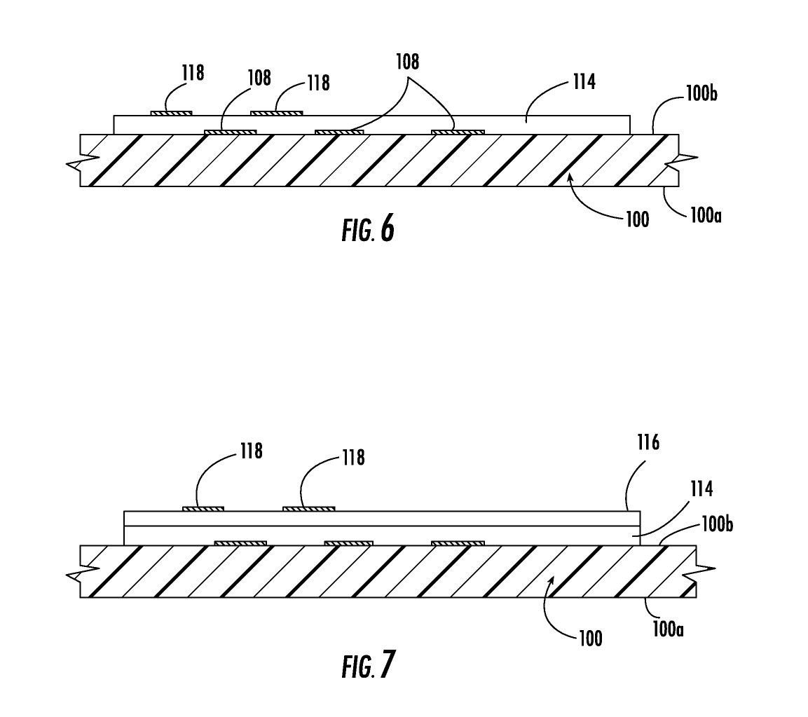

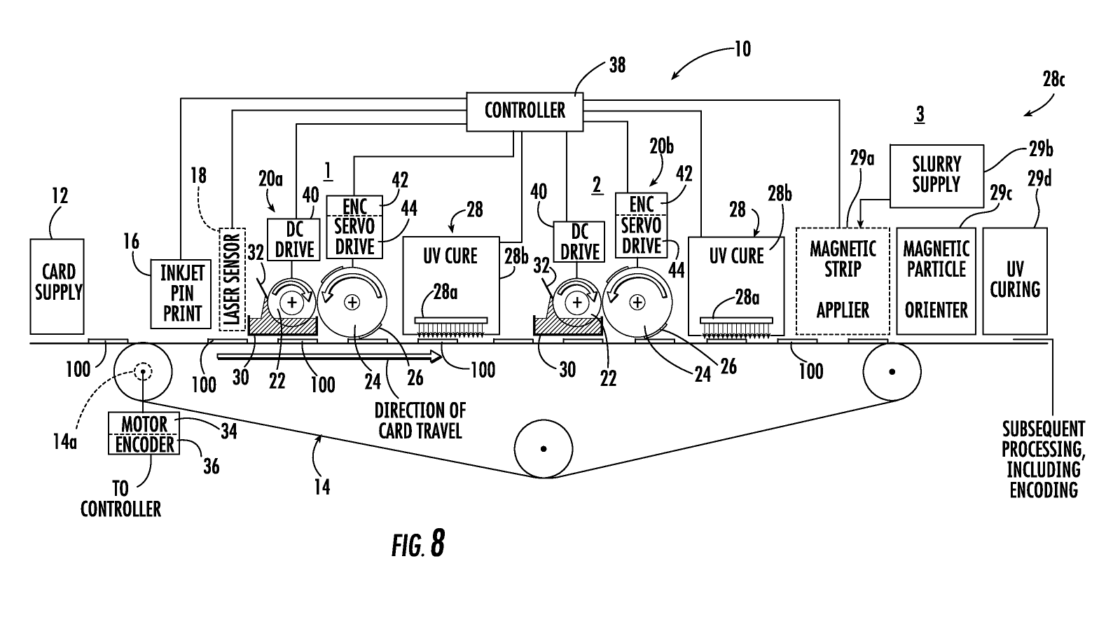

Instructions 106 for use of the phone card are included on the rear surface 100b. A PIN 108 is printed on the rear surface of the phone card, together with a control number 110 as indicated by the dashed lines for the PIN and control number. A release coating 112 is shown in dashed lines as indicating that a release coating could be applied by a first print station, but does not have to be applied depending on the type of substrate material used for the card member. The scratch-off coating 114 is subsequently applied and shown by the solid line. A second coating 116 can be applied over the scratch-off coating as shown in the section view of FIG. 7 or the scratch-off coating could be the only coating as shown in FIG. 6. A second coating could be a security indicia, fingerprint pattern, or could include a security indicia on top as a control code.

FIG. 5 illustrates that a control number 118 could be used as a security indicia such that if the scratch-off coating is removed, and a scratch-off label applied in its place, the control number would not be shown on the scratch-off label. The second layer on top of the initial scratch-off coating could be a printed black ink as noted before.

The present invention now provides an improved method and debit card that can be processed quickly at up to 30,000 to about 50,000 cards per hour and about 500 to about 800 cards per minute, depending on the type of card, number of print stations, and thickness of any applied layers. No scrap is produced as when a web of scratch-off labels or hot stamp foil are used as in the incorporated by reference patent.

It is also possible that solvent coatings could be used. These solvent coatings can be ink with solvents, such as water or other materials, which could be thermal dried. It is also possible to use coatings that are a two-part system that cures similar to epoxy. Other coatings could be used as suggested by those skilled in the art. Also, the card conveying mechanism could be any conveying mechanism suggested by those skilled in the art, including drum, roller or other belt mechanism. A fingerprint pattern could be applied under or over the scratch-off coating as noted before.

FIG. 8 shows the third printing station 28c that has printing components for printing a magnetic strip on the card instead of applying magnetic strip such as from a roll. In this particular example, the planar card member is advanced along a predetermined path of travel and a longitudinal strip of slurry comprising magnetically conductive particles is applied onto the surface of the card member using a magnetic strip applier 49a that is supplied slurry from a slurry supply 29b. The magnetic strip applier could be a combination of an anilox metering roll and plate cylinder combination such as described at printing stations 1 and 2 in which the longitudinal strip of slurry is printed by metering the slurry from an anilox metering roll onto an impression plate and transferring the slurry from the impression plate onto the surface of the planar card member. The magnetically conductive particles that had been applied as a longitudinal strip of slurry are then magnetically aligned using a magnetic particle orienter 29c. This can include an electrical coil or other circuit that magnetically aligns the magnetically conductive particles by applying an electric field to the magnetically conductive particles. The amplitude of a current forming the electric field can be varied to change the magnetism imparted onto the magnetically conductive particles. The longitudinal strip of magnetically conductive particles are then radiation cured 29d such as similar to the UV cure 28b. The card then can be subsequently processed such as encoding data onto the magnetic strip.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed:

1. A method of forming a card having a magnetic strip, comprising the steps of:
advancing a planar card member along a predetermined path of travel, the card member having opposing surfaces;
applying a longitudinal strip of slurry comprising magnetically conductive particles onto a surface of the card member;
magnetically aligning the magnetically conductive particles; and
radiation curing the longitudinal strip of magnetically conductive particles to form a magnetic strip on the surface of the card member.

2. The method according to claim 1, and further comprising encoding data onto the magnetic strip.

3. The method according to claim 1, wherein the step of applying the longitudinal strip of slurry comprises printing the longitudinal strip of slurry.

4. The method according to claim 3, and further comprising printing the longitudinal strip of slurry by metering the slurry from an anilox metering roll onto an impression plate, and transferring the slurry from the impression plate onto the surface of the planar card member.

5. The method according to claim 1, wherein the step of magnetically aligning the magnetically conductive particles comprises applying an electric field to the magnetically conductive particles.

6. The method according to claim 5, and further comprising varying the amplitude of a current forming the electric field to change the magnetism imparted onto the magnetically conductive particles.

7. A debit card, comprising:
a planar card member having opposing surfaces; and
a longitudinal magnetic strip applied onto a surface of the planar card member and formed from a radiation cured slurry of magnetically aligned conductive particles applied onto a surface of the card.

8. The debit card according to claim 7, and further comprising data encoded onto the magnetic strip.

9. A system for forming a card, comprising:
a conveying mechanism for sequentially advancing planar card members along a predetermined path of travel;
a magnetic strip applicator located along the predetermined path of travel configured to apply a longitudinal strip of slurry comprising magnetically conductive particles onto a surface of the card member;
a magnetic particle orienter located along the path of travel and configured to magnetically align the magnetically conductive particles; and
a radiation curing station located along the path of travel and configured to radiation cure the longitudinal strip of magnetically conductive particles.

10. The system according to claim 9, wherein said magnetic strip applicator comprises a flexographic printing station located along the path of travel.
